(19) United States
(12) Patent Application Publication
(10) Pub. No.: US 2018/0223889 A1
(43) Pub. Date: Aug. 9, 2018

(54) METRIC SELF-TAPPING LOCKING SCREW AND THE MANUFACTURING METHOD THEREOF

(71) Applicant: Essence Fastening System (Shanghai) Co., Ltd., Shanghai (CN)

(72) Inventors: Qinfeng Yi, Taicang (CN); Huiying Wang, Heze (CN); Xin'an Li, Taicang (CN)

(21) Appl. No.: 15/587,436

(22) Filed: May 5, 2017

(30) Foreign Application Priority Data
Feb. 5, 2017 (CN) 201710064953.8

(51) Int. Cl. F16B 25/10; B21H 3/02; B21F 45/16; B21K 1/46

(52) U.S. Cl. CPC F16B 25/106; B21H 3/027; B21K 1/46; B21F 45/16; B21H 3/025

(57) ABSTRACT

A metric self-tapping locking screw comprises a screw head which is connected to a thread locking body by a screw rod. The thread locking body and the self-tapping tip are provided with a screw thread on the surface. The self-tapping tip is arranged at the root of the thread locking body; the screw thread adopts the basic structure of the standard ordinary triangular thread. The flank angle back to the fastened surface is 15-20° and the flank angle of the screw thread facing the fastened surface is 30°. The metric self-tapping locking screw in the Invention make the installed parts to be fastened have higher axial clamping force and static loosing moment, which solves the attenuation problem of axial clamping force and static moment of fastened parts.

### CROSS REFERENCE TO RELATED APPLICATIONS

The present application claims the benefit of Chinese Patent Application No. 201710064953.8 filed on Feb. 5, 2017, the contents of which are hereby incorporated by reference.

### TECHNICAL FIELD

The Invention relates to a screw and its manufacturing method, and particularly to a metric self-tapping locking screw and the manufacturing method thereof.

### BACKGROUND

As is known to all, threaded fastening has been widely applied in mechanical equipment, automobile manufacturing, household appliance and daily life. Moreover, the threaded fastening is requisite for the fastening and connection between the mechanical parts. In many industries, self-tapping locking screw is increasingly applied in order to reduce the intermediate link. Therefore, China has published such national standards as Screw Thread Shanks for Thread Forming Screw—Metric Coarse Thread Series (GB/T 6559-1986); however, these standards cannot satisfy the application requirements of high mounting torque, high axial clamping force and high locking performance. Most of fastening technologies appropriate for application with high requirements are monopolized by the foreign patents and enterprises. It is urgently needed to develop a metric coarse-thread self-tapping locking screw and popularize the fastening technology in manufacturing industry in China.

### SUMMARY OF THE INVENTION

The Invention is to provide a metric self-tapping locking screw and the manufacturing method appropriate for fastening applications of base materials such as high-strength cold-rolled steel, aluminum alloy castings and plastic, and application of the fastening technology with lower tapping moment and higher static loosing moment, so that the installed parts to be fastened have higher axial clamping force, which solves the attenuation problem of axial clamping force and static moment of fastened parts.

The technical scheme of the Invention is realized as follows: a metric self-tapping locking screw comprises a screw head, a screw rod, a thread locking body, a self-tapping tip and a screw thread; the screw head is connected to the thread locking body with the screw rod; the thread locking body and the self-tapping tip are provided with the screw thread on the surface; the self-tapping tip is arranged at the root of the thread locking body; the screw thread adopts the basic structure of the standard ordinary triangular thread; a flank angle of the screw thread back to the fastened surface is 15-20° and another flank angle of the screw thread facing the fastened surface is 30°; a crest of said screw thread is in a plane transition structure or a natural circular arc transition structure.

Preferably, the screw thread is divided into eight equal parts by eight mean lines; the eight mean lines include one-eighth line, two-eighth line, three-eighth line, four-eighth line, five-eighth line, six-eighth line, seven-eighth line and eight-eighth line; the intersection of the four-eighth line and the crest is a first crossing point; the intersection of the two-eighth line and the crest side back to the fastened surface is a second crossing point; a tangency arc between the first crossing point and the second crossing point is a rounded root of thread.

Preferably, the two-eighth line and the screw thread intersect at a third tangency point; the three-eighth line and the screw thread intersect at a forth crossing point; a line connected the third tangency point and the forth crossing point forms a thread root-diameter angle with the two-eighth line; the thread root-diameter angle is 20°.

Preferably, the rounded root of thread constitutes the asymmetry root-diameter structure of the metric self-tapping locking screw together with the thread roof-diameter angle.

Preferably, the horizontal cross-section of said self-tapping tip is in a triangular circular arc transition structure and forms an angle of 8-15° with the plane of the thread locking body; the crests of the self-tapping tip transit to the thread locking body from small to large in a cone way and the screw threads on the thread locking body gradually diminish to said self-tapping tip in compliance with the crest shape. The length of the screw thread on the self-tapping tip is equal to or less than the nominal diameter of the screw thread on the thread locking body.

The Invention also provides a manufacturing method of the metric self-tapping locking screw, comprising the following steps:

Preparing a wire coil for cold heading to manufacture the cylinder of the metric self-tapping locking screw; the circular section diameter of the wire coil for cold heading is equal or greater than the diameter of the screw head;

Cutting out the wire coil for cold heading by a cold header to acquire a piece of the wire coil for cold heading with the length equal to the metric self-tapping locking screw;

Using the main die and the punch die of the cold header for mutual cold extrusion of the piece of the wire coil; the screw head, the screw rod, the thread locking body and the self-tapping tip are formed on the surface of the piece of the wire coil to acquire the screw blank;

Rolling and extruding the screw blank by thread rolling and molding equipment and self-tapping screw die so that the screw thread is formed on the surface of the thread locking body and the self-tapping tip to acquire the semi-finished screw product;

Conducting carburizing treatment and thermal refining on the surface of the semi-finished screw product to enhance the hardness and strength of the semi-finished screw product and acquire the finished metric self-tapping locking screw.

Preferably, the wire coil for cold heading comprises low-carbon cold-heading steel, low-carbon alloy steel, martensitic stainless steel and low austenitic stainless steel.

Preferably, an extrusion forming mode of 1-die 2-punch or 2-die 4-punch is adopted for the mutual cold extraction of the wire coil by means of the main die and the punch die of the cold header.

Preferably, the screw thread surface is provided with a zinc-nickel alloy coating.

The positive advantages of the Invention are as follows: the metric self-tapping locking screw in the Invention is applied to fastening applications of base materials such as high-strength cold-rolled steel, aluminum alloy castings and plastic, and application of the fastening technology with lower tapping moment and higher static loosing moment, so that the installed parts to be fastened have higher axial clamping force, which solves the attenuation problem of axial clamping force and static moment of fastened parts.

### BRIEF DESCRIPTION OF THE DRAWINGS

FIG. 1 is a structural diagram of the metric self-tapping locking screw of the Invention;

FIG. 2 is a structural schematic diagram of the metric self-tapping locking screw of the Invention;

FIG. 3 is a structural schematic diagram of the thread of the metric self-tapping locking screw of the Invention.

### DETAILED DESCRIPTION OF THE PREFERRED EMBODIMENTS

The technical scheme of the Invention is further described by the preferred Embodiments of the Invention in combination with the Drawings.

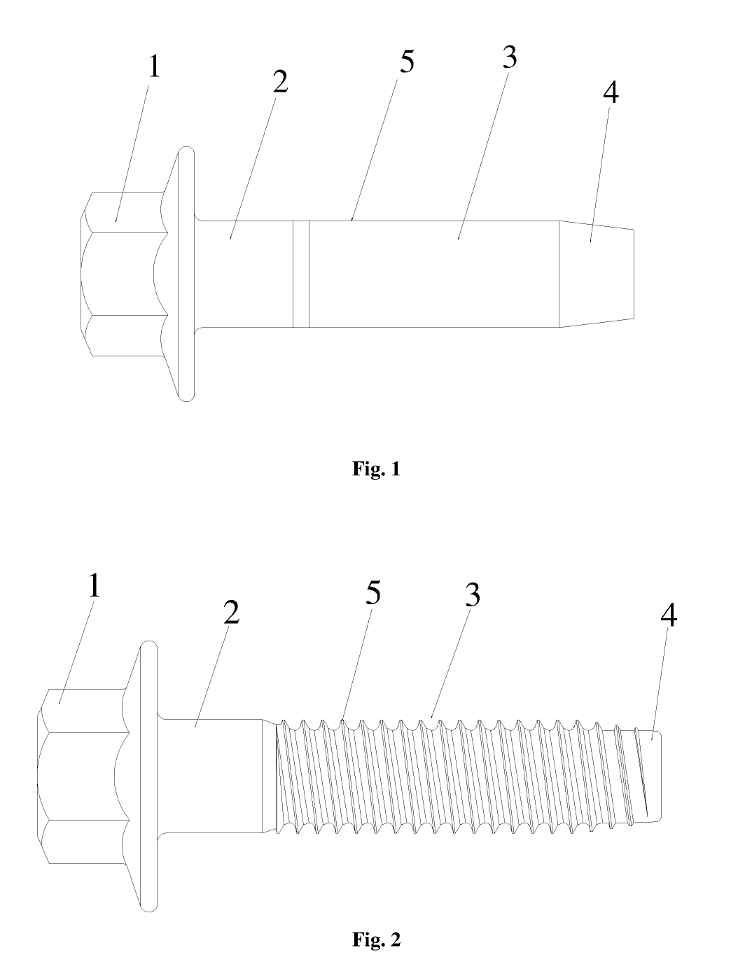

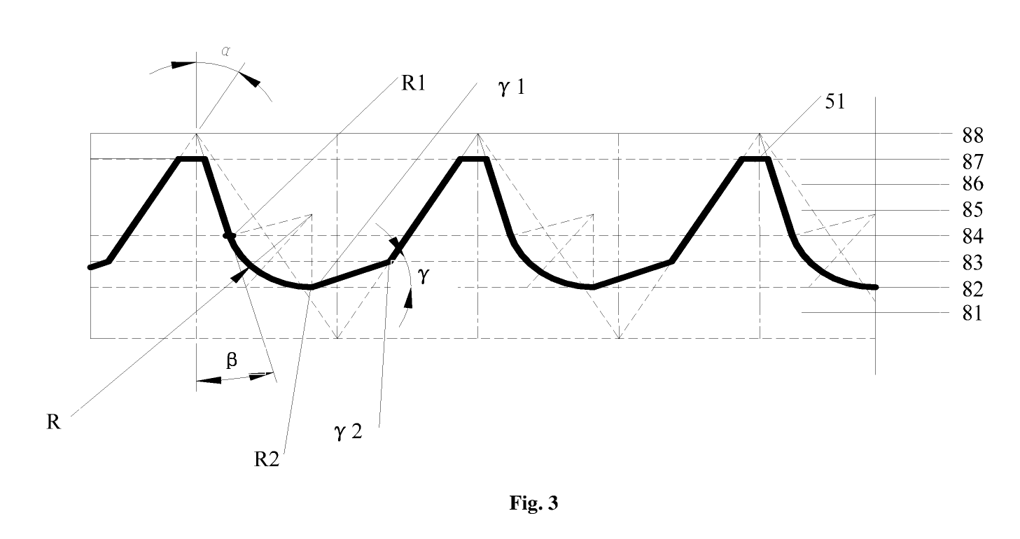

As shown in FIG. 1, FIG. 2 and FIG. 3, a metric self-tapping locking screw of the Invention comprises a screw head 1, a screw rod 2, a thread locking body 3, a self-tapping tip 4 and a screw thread 5; the screw head 1 is connected to the thread locking body 3 with the screw rod 2; the thread locking body 3 and the self-tapping tip 4 are provided with the screw thread 5 on the surface; the self-tapping tip 4 is arranged at the root of the thread locking body 3; the screw thread 5 adopts the basic structure of the standard ordinary triangular thread; a flank angle β of the screw thread 5 back to the fastened surface is 15-20° and a flank angle α facing the fastened surface is 30°; a crest 51 of the screw thread 5 is in a plane transition structure or a natural circular arc transition structure.

The screw thread 5 is divided into eight equal parts by eight mean lines; the eight mean lines include one-eighth line 81, two-eighth line 82, three-eighth line 83, four-eighth line 84, five-eighth line 85, six-eighth line 86, seven-eighth line 87 and eight-eighth line 88; a intersection of the four-eighth line 84 and a crest is the first crossing point R1; a intersection of the two-eighth line 82 and a flank side back to the fastened surface is the second crossing point R2; a tangency arc between the first crossing point R1 and the second crossing point R2 is the rounded root of thread R; in this way, the fastening performance can be improved.

The two-eighth line 82 and the screw thread 5 intersect at the third tangency point γ1; the three-eighth line 83 and the screw thread 5 intersect at the forth crossing point γ2; the line connected the third tangency point γ1 and the forth crossing point γ2 forms the thread root-diameter angle γ with the two-eighth line 82; the thread root-diameter angle γ is 20°.

The rounded root of thread R constitutes the asymmetry root-diameter structure of the metric self-tapping locking screw together with the thread roof-diameter angle γ. The helix angle of the helical line of stressed flank side formed by the asymmetry root-diameter structure is smaller than the helix angle of ordinary screw, and the helical line of stressed flank side formed by the asymmetry root-diameter structure forms the greater axial clamping force borne by the thread together with the connected part, resulting in the locking effect without any sliding or loosening; the asymmetry root-diameter structure is properly added with the thread root diameter of the screw thread 5 to improve the rupture moment of the whole metric self-tapping locking screw.

The cross-section of the self-tapping tip 4 is in a triangular circular arc transition structure and forms an angle of 8-15° with the plane of the thread locking body 3; the crests of the self-tapping tip 4 transit to the thread locking body 3 from small to large in a cone way and the screw threads 5 on the thread locking body 3 gradually diminish to the self-tapping tip 4 in compliance with the crest shape. The length of the screw thread 5 on the self-tapping tip 4 is equal to or less than the nominal diameter of the screw thread 5 on the thread locking body 3. When the fastened part passes through the self-tapping tip 4, the thread is gradually formed from small to large. The crest angle of main thread is 10-15° smaller than the ordinary triangular thread; the screwing resistance of the main thread and the connected part is reduced and the tapping and locking performance of the thread is greatly improved. Due to the asymmetric angles on both sides of the main crest of the self-tapping locking thread, the helical lines formed by tapping and unscrewing are misaligned. As a result, the frictional force produced by loosening is greater than that formed by the ordinary triangular self-tapping thread, which provides a better locking performance.

The manufacturing method of the metric self-tapping locking screw of the Invention includes the following steps:

Step I: Preparing a wire coil for cold heading to manufacture the cylinder of the metric self-tapping locking screw; the circular section diameter of the wire coil for cold heading is equal or greater than the diameter of the screw head 1;

Step II: Cutting out the wire coil for cold heading by a cold header to acquire a piece of the wire coil for cold heading with the length equal to the metric self-tapping locking screw;

Step III: Using the main die and the punch die of the cold header for mutual cold extrusion of the piece of the wire coil; the screw head 1, the screw rod 2, the thread locking body 3 and the self-tapping tip 4 are formed on the surface of the piece of the wire coil to acquire the screw blank;

Step IV: Rolling and extruding the screw blank by thread rolling and molding equipment and self-tapping screw die so that the screw thread 5 is formed on the surface of the thread locking body 3 and the self-tapping tip 4 to acquire the semi-finished screw product;

Step V: Conducting carburizing treatment and thermal refining on the surface of the semi-finished screw product of screw thread 5 to enhance the hardness and strength of the semi-finished screw product and acquire the finished metric self-tapping locking screw.

The wire coil for cold heading includes low-carbon cold-heading steel, low-carbon alloy steel, martensitic stainless steel and low austenitic stainless steel. Various raw materials can be used to manufacture the metric self-tapping locking screw, reducing the original procurement difficulty of manufacturing of the metric self-tapping locking screw.

An extrusion forming mode of 1-die 2-punch or 2-die 4-punch is adopted for the mutual cold extraction of the wire coil by means of the main die and the punch die of the cold header, which facilitates machining of wire coil by the cold header and reduces the production difficulty of the screw blank.

The surface of the screw thread 5 is coated with a zinc-nickel alloy coating which protects the surface of the screw thread 5 and provides higher corrosion resistance for the screw thread 5.

In conclusion, the metric self-tapping locking screw in the Invention is applied to fastening applications of base materials such as high-strength cold-rolled steel, aluminum alloy castings and plastic, and application of the fastening technology with lower tapping moment and higher static loosing moment, so that the installed parts to be fastened have higher axial clamping force, which solves the attenuation problem of axial clamping force and static moment of fastened parts. The manufacturing method of the metric self-tapping locking screw of the Invention is characterized by simple steps, low cost and easy operation.

The above embodiments are the further detailed descriptions for the technical problems, technical schemes and the beneficial effects of the Invention. It should be understood that the above are the preferred embodiments rather than the limitations of the Invention. Any amendment, equivalent replacement and improvement made within the range of the spirit and rule of the Invention shall be included in the protection scope of the Invention.

What is claimed is:

1. A metric self-tapping locking screw, comprising a screw head, a screw rod, a thread locking body, a self-tapping tip and a screw thread; the screw head is connected to the thread locking body with the screw rod; the thread locking body and the self-tapping tip are provided with the screw thread on the surface; the self-tapping tip is arranged at the root of the thread locking body; the screw thread adopts the basic structure of the standard ordinary triangular thread; a flank angle of the screw thread back to the fastened surface is 15-20° and another flank angle of the screw thread facing the fastened surface is 30°; a crest of the screw thread is in a plane transition structure or a natural circular arc transition structure.

2. The metric self-tapping locking screw according to claim 1, wherein the screw thread is divided into eight equal parts by eight mean lines; the eight mean lines include one-eighth line, two-eighth line, three-eighth line, four-eighth line, five-eighth line, six-eighth line, seven-eighth line and eight-eighth line; the intersection of the four-eighth line and the crest is a first crossing point; the intersection of the two-eighth line and the flank side back to the fastened surface is a second crossing point; a tangency arc between the first crossing point and the second crossing point is a rounded root of thread.

3. The metric self-tapping locking screw according to claim 2, wherein the two-eighth line and the screw thread intersect at a third tangency point; the three-eighth line and the screw thread intersect at a forth crossing point; line connected the third tangency point and the forth crossing point forms a thread root-diameter angle with the two-eighth line; the thread root-diameter angle is 20°.

4. The metric self-tapping locking screw according to claim 3, wherein the rounded root of thread constitutes the asymmetry root-diameter structure of the metric self-tapping locking screw together with the thread roof-diameter angle.

5. The metric self-tapping locking screw according to claim 1, wherein the cross-section of the self-tapping tip is in a triangular circular arc transition structure and forms an angle of 8-15° with the plane of the thread locking body; the crests of the self-tapping tip transit to the thread locking body from small to large in a cone way and the screw threads on the thread locking body gradually diminish to the self-tapping tip in compliance with the crest shape; the length of the screw thread on the self-tapping tip is equal to or less than the nominal diameter of the screw thread on the thread locking body.

6. A manufacturing method of the metric self-tapping locking screw, comprising the following steps:
preparing a wire coil for cold heading to manufacture the cylinder of the metric self-tapping locking screw; the circular section diameter of the wire coil for cold heading is equal or greater than the diameter of the screw head;
cutting out the wire coil for cold heading by a cold header to acquire a piece of the wire coil for cold heading with the length equal to the metric self-tapping locking screw;
using the main die and the punch die of the cold header for mutual cold extrusion of the piece of the wire coil; the screw head, the screw rod, the thread locking body and the self-tapping tip are formed on the surface of the piece of the wire coil to acquire the screw blank;
rolling and extruding the screw blank by thread rolling and molding equipment and self-tapping screw die so that the screw thread is formed on the surface of the thread locking body and the self-tapping tip to acquire the semi-finished screw product; and
conducting carburizing treatment and thermal refining on the surface of the semi-finished screw product of the screw thread to enhance the hardness and strength of the semi-finished screw product and acquire the finished metric self-tapping locking screw.

7. The manufacturing method of the metric self-tapping locking screw according to claim 6, wherein the wire coil for cold heading comprises low-carbon cold-heading steel, low-carbon alloy steel, martensitic stainless steel and low austenitic stainless steel.

8. The manufacturing method of the metric self-tapping locking screw according to claim 6, wherein an extrusion forming mode of 1-die 2-punch or 2-die 4-punch is adopted for the mutual cold extraction of the wire coil by means of the main die and the punch die of the cold header.

9. The manufacturing method of the metric self-tapping locking screw according to claim 6, wherein the screw thread surface is coated with a zinc-nickel alloy coating.
